(19) United States
(12) Patent Application Publication
(10) Pub. No.: US 2019/0205283 A1
(43) Pub. Date: Jul. 4, 2019

(54) Personal computer (PC)

(71) Applicant: Maria Louise Jones, Marysville, WA (US)

(72) Inventor: Maria Louise Jones, Marysville, WA (US)

(21) Appl. No.: 15/732,806

(22) Filed: Jan. 3, 2018

(51) Int. Cl. G06F 15/02; H04N 7/14

(52) U.S. Cl. CPC G06F 15/0225; H04N 7/141

(57) ABSTRACT

The Abstracts of Disclosure are shown in the TIME publications of the Apple I & Apple II made by Steven Paul Jobs & Steve Wozniak, Co-Founders of Apple Computer Inc; & The iMac & The Macintosh Computers made by Steven Paul Jobs, Co-Founder of Apple Computer, Inc.

The Abstracts of Disclosure are also written in a book by Bill Gates called THE ROAD AHEAD: in 1968 Bill Gates & Paul Allen worked at a small computer terminal at Lakeside School inputting a BASIC Code into a computer system to play games. (Page 3 of The Road Ahead.

I'm submitting a drawing of the screen & a typewriter I envisioned to be part of the personal computer as discussed in 1975 with Bill Gates Jr.

I'm submitting my original idea of the Personal Computer as discussed with Bill Gates Jr. in 1975; before the Personal Computer existed.

### STATEMENT OF FEDERALLY SPONSORED RESEARCH & DEVELOPMENT

Bureau of Labor Statistics: “A Shaker Approach to Web Site Design; Jul. 19, 2008: Michael D. Levi (1997);

National Center for Education Statistics, Institute of Education Sciences, US Department Of Education, Washington D.C.: Teachers' Use of Educational Technology in U.S. Public Schools, 2009; Gray L., Thomas N, & Lewis L. (2010) (NCES 2010-040).

A portion of the disclosure of this patent document contains material which is subject to (copy right or mask work) protection. The copy right or mask work owner has no objection to the fax reproduction by anyone of the patent document or the patent disclosure as it appears in the PTO patent file or records, but otherwise reserves all (copy right or mask work) rights whatsoever.

### CROSS REFERENCES TO RELATED APPLICATIONS

a. Apple Computer 1: Steven Paul Jobs & Steve Wozniak; Co-Founders of Apple Computer Inc. 1976;

b. Apple II: Steven Paul Jobs & Steve Wozniak; Co-Founders of Apple Computer Inc. 1979;

c. Macintosh Computer: Steven P. Jobs & Steve Wozniak; Co-Founders of Apple Computer Inc. 1984;

d. iMac Computer: Steve P. Jobs; Co-Founder of Apple Computer Inc. 1998;

e. iBook Laptop Computer: Steven P. Jobs; Co-Founder of Apple Computer Inc., Jonathan Ive-VP of Industrial Design @ Apple Computer Inc.; Jon Rubinstein-Sr. VP of hardware Engineering @ Apple Computer, Inc. 1999;

f. iPhone (cell phone, iPod & mini internet computer): Steven P. Jobs Co-Founder of Apple Computer Inc.; Michel Guillemot Developer & Founder of Gameloft2007.

g. iPad (tablet computer): Steven P. Jobs Co-Founder of Apple Computer Inc., Jon Ive VP of Industrial Design @ Apple Computer & The Apple Computer Developing Team.

h. BASIC Code (the language of the computer) Monte Davidoff developer & bought by Bill Gates III Jr.

### THE NAMES OF THE PARTIES TO A JOINT RESEARCH AGREEMENT OF THE PERSONAL COMPUTER INVENTION

Maria Louise Jones (widow) from Marysville, Wash. USA;

William Henry Gates III Jr. from Medina, Wash. USA; &

Steven Paul Jobs (deceased) from Palo Alto, Calif. USA.

Note: Giving credit to these two men who were involved in the development & designs of the Personal Computer Industry back in the 1970's because they made the vision happen as describe in the patent invention information & history of the Personal Computer.

### PATENT SPECIFICATIONS OF THE PERSONAL COMPUTER

### Background of the Personal Computer

I first met Bill Gates Jr. when he was ready to give up on Microsoft Computer & flew out of his office (a motel room in New Mexico) because he was upset about the need for the computer code called BASIC, which is the computers language code. Bill met a man in New Mexico that had a small computer box that needed the Basic Code as the small computer can do nothing without the computers code: Basic. Bill also needed the vision as to what the potential of the Personal Computer could do with the hardware screen & keyboard (typewriter) to input graphics & characters and display graphics & characters on the screen (monitor). We talked for a few hours at his place in the University District about the potential of the Personal Computer & what it could do. Bill Gates decided to stay at Microsoft & develop the software needed for the Personal Computer.

Steven Paul Jobs was living in Palo Alto, Calif. & had invented something called the blue box which was an interception devise that could intercept & make phone calls around the USA.

In 1976, Steven P. Jobs & Steve Wozniak came up with some computer hardware which was basically the internal parts of a small computer & a keyboard for inputting information into the computer; (parts of the hardware that would become the Personal Computer of today). Steve Jobs & Steve Wozniak called this hardware Apple 1, 1976.

### BRIEF SUMMARY OF THE PERSONAL COMPUTER (PC) & DESCRIPTION

My first vision of the Personal Computer in 1975 was while talking with Bill Gates Jr., Co-Founder of Microsoft Corporation in Seattle, Wash. USA. The screen was referenced in type like a television screen that could display graphics, images & typed characters that were input into the small computer via computer codes (the language of the computer) using a typewriter (keyboard).

In 1976, Steven P. Jobs & Steve Wozniak made the first known prototype of a Personal Computer using internal computer parts on a circuit board & a keyboard called Apple I.

In 1979 Steve Jobs & Steve Wozniak (Co-Founders of Apple Computer, Inc.) made a personal computer in a case with a screen (monitor), the code was located in the computer; & a typewriter (keyboard).connected to the computer; it was called Apple II.

Now Personal Computers come in all sizes & consist of the computer circuits, batteries, silicon chips & codes; screens for viewing graphics, typed characters; & images; & a keyboard which is the same as the use of an old typewriter connected to the Computer electronically. PC's now have a mouse for quick click action on typed characters. Some have telephones as part of the computer unit itself.

### A DETAILED DESCRIPTION OF THE PERSONAL COMPUTER

The Personal Computer is more than just an electronic box with wires, circuit boards, connectors, a keyboard (typewriter) & a monitor (screen). It now has multiple program codes that bring it to life. We have programs that are designed and used for different specifications depending on the area needed. The USA Government uses specialized programs designed for their specific departmental usages. (IRS, Social Security Administration, Department of Social & Health Service, etc.

Personal Computers connect to other personal computers via the World Wide Web (internet).

They can upload & download information from & to the Hard Drive of the Computer, from a CD disk, from an email address via internet service providers such as Google, iCloud or MSN.

Science uses Personal Computers to store calculate formulas, store information, test & diagnosis for diseases, etc.

Before Personal Computers existed, Scientist would have to manually insert codes (the language of the computer) which was a tedious task to say the least, just to get the numbers they needed for the tests & experiments.

Average people are able to run small businesses from their homes or use them for correspondence to their family & friends via email service providers.

Businesses & Governments are able to conduct their business at a faster rate than ever & store the information on their hard drive (computer), on CD's or on templates made for specific purposes as needed by their business or government entity.

1. In 1975, I talked with Bill Gates Jr. a.k.a. William Henry Gates III Jr. about my vision of The Personal Computer using a screen (like the ones on television sets) that can display images, graphics & typed characters into the computer to display on the screen (monitor). Monte Davidoff's Basic Code could be used to complete the process described above.

2. The use of a typewriter (keyboard) to input typed characters into the computer system rather than the tedious time it did take to manually insert the strips of code (Monte Davidoff's Basic Computer Code) into the large computers used by Scientist before the personal computer was invented.

3. The combining of the computer circuit boards, screen (monitor) & the typewriter (keyboard) into a complete unit called the Personal Computer.

4. A telephone that has a screen to talk live with people that also have a telephone that has a screen (somewhat like the Jetson's cartoon). We now have cell phones that contain personal computers that have screens using Skype to talk live.
